(19) United States
(12) Patent Application Publication
(10) Pub. No.: US 2007/0144844 A1
(43) Pub. Date: Jun. 28, 2007

(54) Floating spring divider for a shock absorber in automobile

(76) Inventors: Brent Riley, Yorba Linda, CA (US); Jason Pappo, Chino Hills, CA (US); David Boutwell, Los Angeles, CA (US)

Correspondence Address: YING CHEN, 255 S. GRAND AVE., # 215, LOS ANGELES, CA, 90012, US

(21) Appl. No.: 11/591,439

(22) Filed: Oct. 31, 2006

Related U.S. Application Data
(60) Provisional application No. 60/732,289, filed on Oct. 31, 2005.

(51) Int. Cl. F16F 9/50

(52) U.S. Cl. 188/281

(57) ABSTRACT

A divider for use between two springs in a shock absorber in an automobile, including a bottom ring, a top ring fastened to the bottom ring, and a sleeve retained inside the top and bottom rings. The sleeve is made of a plastic material having good wearability, and the top and bottom rings are preferably made of anodized aluminum. The spring divider provides good wearability and enhanced appearance.

This application claims priority from U.S. Provisional Patent Application No. 60/732,289, filed Oct. 31, 2005, which is herein incorporated by reference in its entirety.

### BACKGROUND OF THE INVENTION

1. Field of the Invention

This invention relates to automobile parts, and in particular, it relates to a floating spring divider in a shock absorber.

2. Description of the Related Art

A shock absorber in an automobile has two springs coiled around a shaft with a ring-shaped divider between the upper and lower springs. The divider holds one end of each spring, and moves up and down along the shaft when the springs are compressed. The inner surface of the divider contacts the shaft and receives wear when the automobile is in use. Conventional spring dividers are typically made of a single piece of plastic material such as urethane that has good wearability.

### SUMMARY OF THE INVENTION

The present invention provides a floating spring divider that has improved appearance and maintains the wearability of conventional designs.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a divider for use between two springs in a shock absorber in an automobile, including a bottom ring, a top ring fastened to the bottom ring, and a sleeve made of a plastic material retained inside the top and bottom rings.

It is to be understood that both the foregoing general description and the following detailed description are exemplary and explanatory and are intended to provide further explanation of the invention as claimed.

### BRIEF DESCRIPTION OF THE DRAWINGS

FIG. 1(a) illustrates a part of a shock absorber including the floating spring divider according to an embodiment of the present invention.

FIG. 1(b) is a magnified view of a portion of FIG. 1(a).

FIGS. 2(a)-(b) are perspective and exploded views of the spring divider of FIG. 1(a), respectively.

FIGS. 3(a)-(d) are perspective, side elevation, top and side cross-sectional views, respectively, of the bottom piece of the spring divider.

FIGS. 4(a)-(d) are perspective, side elevation, top and side cross-sectional views, respectively, of the top piece of the spring divider.

FIGS. 5(a)-(c) are perspective, top and side elevation views, respectively, of the inner sleeve of the spring divider.

### DETAILED DESCRIPTION OF THE PREFERRED EMBODIMENTS

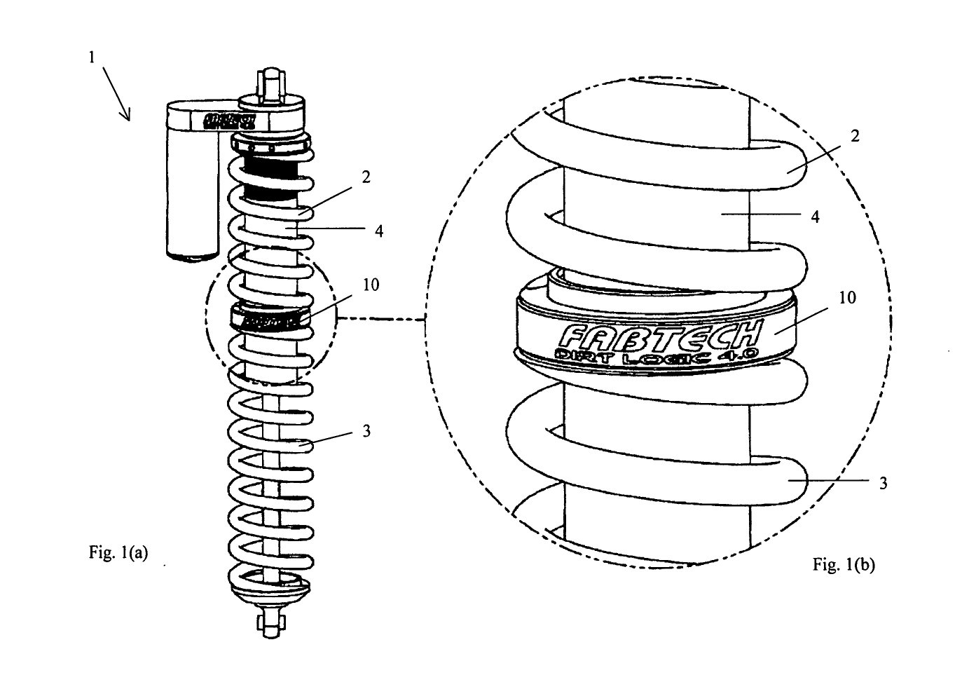

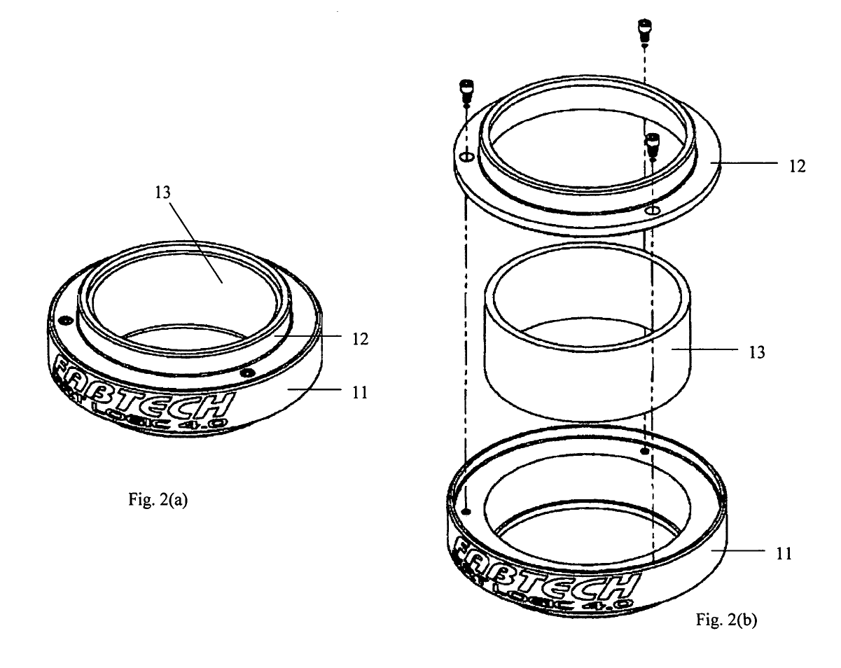

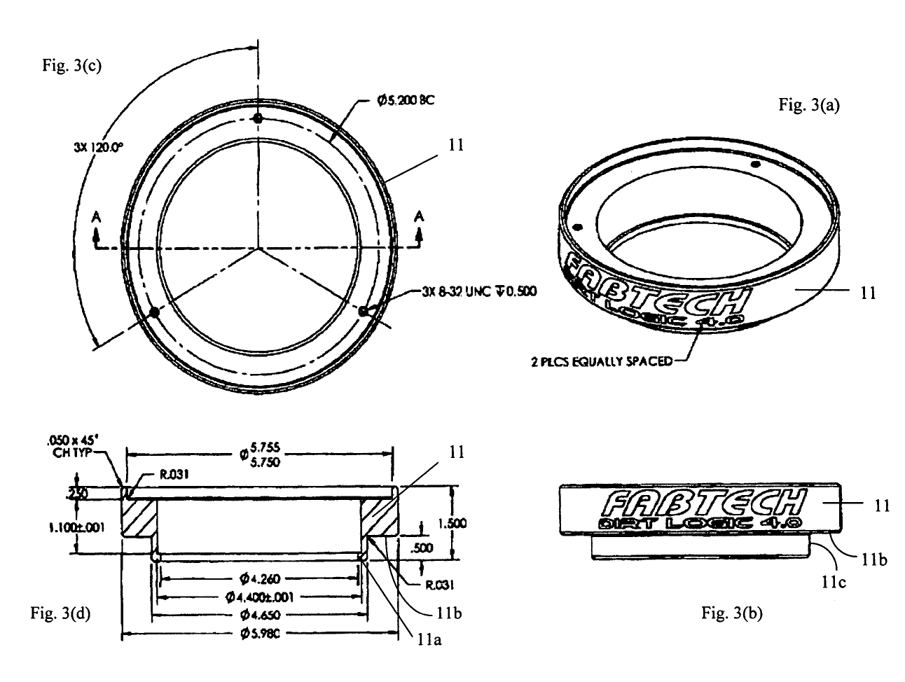

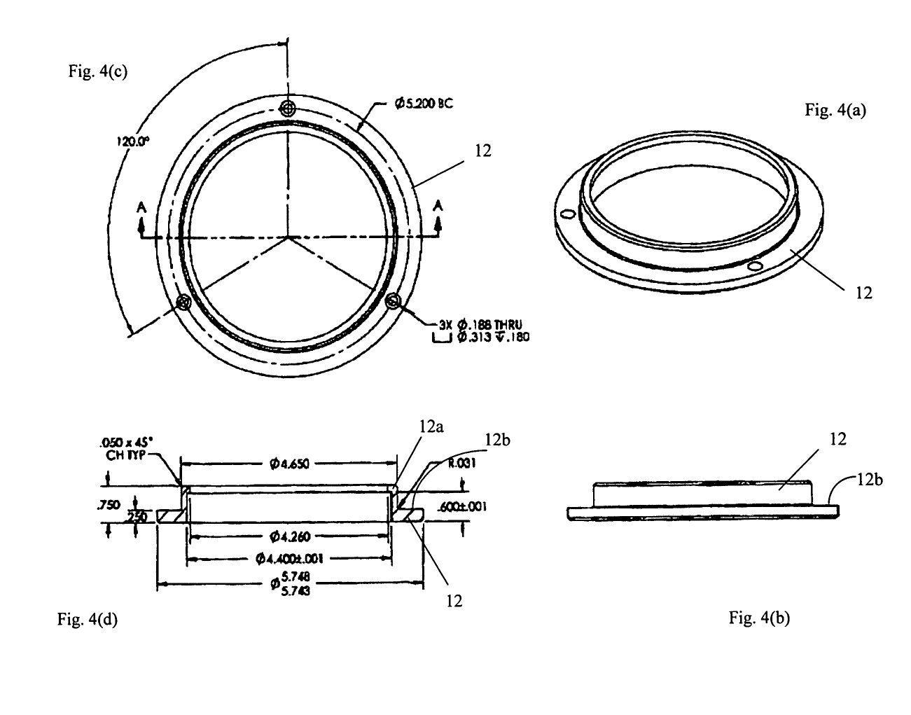

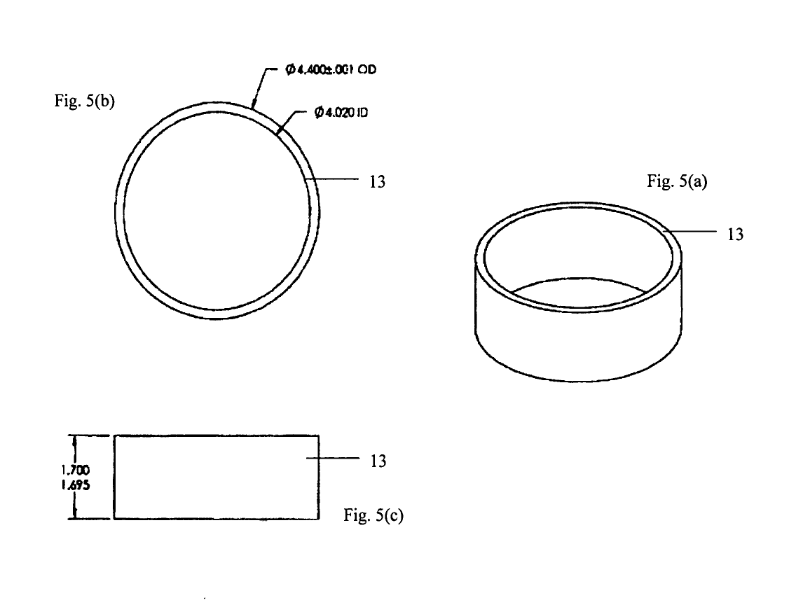

As shown in FIGS. 1(a) and 1(b), the shock absorber 1 includes upper and lower springs 2 and 3, and a floating spring divider 10 between the upper and lower springs. The divider has a ring shape and is disposed around a shaft body 4 of the shock absorber (typically made of steel). As shown in FIGS. 2(a) and 2(b), the spring divider is formed of a bottom ring 11, a top ring 12 fastened to the bottom ring by a number of screws or other suitable attachment devices, and an inner sleeve 13 that is retained inside the bottom and top rings. As shown in FIGS. 3(a)-(d), the bottom ring has a uniform inner diameter except that at the bottom end where a flange 11a extends inwardly to form a step against which the inner sleeve 13 rests. As shown in FIGS. 4(a)-(d), the top ring also has a uniform inner diameter, which is identical to the inner diameter of the bottom ring, except at the top end where a flange 12a extends inwardly to form a step. As shown in FIGS. 5(a)-(c), the inner sleeve 13 has a cylindrical shape with an outer diameter approximately the same as the inner diameter of the top and bottom rings. When assembled, the inner sleeve 13 fits inside the top and bottom rings and is retained by the flanges 11a and 12a. The length of the inner sleeve 13 is approximately the same as the distance between the flanges 11a and 12a when assembled, so the inner sleeve does not move vertically inside the top and bottom rings. The radial widths of the flanges 11a and 12a are less than the thickness of the inner sleeve so they do not extend beyond the inner surface of the inner sleeve.

The bottom ring 11 has a portion 11c with a smaller outer diameter than the rest of the ring, forming a step 11b for accommodating the upper end of the lower spring 3. Similarly, a step 12b is formed in the upper ring for accommodating the lower end of the upper spring 2.

The inner sleeve 13 is made of a plastic material having good wear properties, such as Delrin(®), UHMW or similar plastic. The top and bottom rings 12 and 11 may be made of a metal or other suitable materials. Preferably, they are made of aluminum. The aluminum is preferably anodized. The outer side surface of the divider may be inscribed with a logo, a part number, or other suitable insignia. Note that although in FIG. 2(b) the outer side surface is shown to be a part of the bottom ring, it may also be a part of the top ring, or both.

A floating spring divider according to embodiments of the present invention provides good wearability and enhanced appearance.

It will be apparent to those skilled in the art that various modification and variations can be made in the floating spring divider of the present invention without departing from the spirit or scope of the invention. In particular, while various dimensions of the parts are provided in the drawings, the invention is not limiter by these dimensions and other suitable dimensions may be used for the invention. Thus, it is intended that the present invention cover modifications and variations that come within the scope of the appended claims and their equivalents.

What is claimed is:

1. A divider for use between two springs in a shock absorber in an automobile, comprising:
a bottom ring;
a top ring fastened to the bottom ring; and
a sleeve made of a plastic material retained inside the top and bottom rings.

2. The divider of claim 1, wherein each of the bottom ring and the top ring has a flange extending inwardly to form a step for retaining the sleeve.

3. The divider of claim 1, wherein the bottom ring and the top ring are made of metal.
